(19) United States
(12) Patent Application Publication
(10) Pub. No.: US 2016/0278362 A1
(43) Pub. Date: Sep. 29, 2016

(54) INSECT SWATTER

(71) Applicant: Richard Elliott ROYAL, Umatilla, FL (US)

(72) Inventor: Richard Elliott ROYAL, Umatilla, FL (US)

(21) Appl. No.: 14/670,725

(22) Filed: Mar. 27, 2015

(51) Int. Cl. A01M 3/02; D04C 1/06

(52) U.S. Cl. CPC A01M 3/02; D04C 1/06

(57) ABSTRACT

An insect swatter formed from a plurality of limp fibers into a handle portion and a striking portion is provided. The handle portion is formed by the portion of the limp fibers that are braided together, while the striking portion is formed from the remaining portion of the limp fibers that is left unbraided. The limp fibers are made from material that exhibits a limp, soft and resilient manner for delivering a soft impact while also exhibiting properties tolerant to shape changes, for instance, when for fitting into tight spaces.

### BACKGROUND OF THE INVENTION

The present invention relates to pest control devices and, more particularly, to an insect swatter formed from a plurality of limp fibers for advantageously striking the target.

Current insect swatters have some combination of rigid handles attached to a hard striking surface, whereby the striking surface mechanically crushes the insect against a hard surface. The striking surface typically is a round or rectangular sheet of hard, albeit vented, material. Such striking surface material resists changes in shape, preventing use in tight spaces. Moreover, the hard material results in crushing the targeted insect leaving a messy residue. The mess requires cleaning both the swatter unit and the surface on which the insect was crushed. Additionally, traditional insect swatters require the user to wait for the combination of having the targeted insect pause somewhere that is both sufficiently open and resilient enough to accommodate the impact of the striking blow.

As can be seen, there is a need for an insect swatter formed from a plurality of limp fibers for advantageously striking the target whereby the user can merely stun, mess-free, the insect even in tight spaces.

### SUMMARY OF THE INVENTION

In one aspect of the present invention, an insect swatter formed from a plurality of limp fibers, wherein a first portion of the plurality of limp fibers is braided.

In another aspect of the present invention, an insect swatter provides a first portion of a plurality of limp fibers forming a striking portion; a second portion of the plurality of limp fibers braided to form a handle portion; and two bands, wherein each band is bound tightly about the braided first portion of the plurality of limp fibers, and wherein each band is disposed near opposing ends thereof.

In yet another aspect of the present invention, a method of making an insect swatter that can strike in tight spaces from a unitary limp material includes shredding the unitary limp material into a plurality of limp fibers; braiding a first portion of the plurality of limp fibers; and tightly binding at least one limp fiber around each opposing end of the braided first portion.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention, shown in use; and

FIG. 2 is a perspective view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an insect swatter formed from a plurality of limp fibers into a handle portion and a striking portion. The handle portion is formed by the portion of the limp fibers that are braided together, while the striking portion is formed from the remaining portion of the limp fibers that is left unbraided. The limp fibers are made from material that exhibits a limp, soft and resilient manner for delivering a soft impact while also exhibiting properties tolerant to shape changes, for instance, when for fitting into tight spaces.

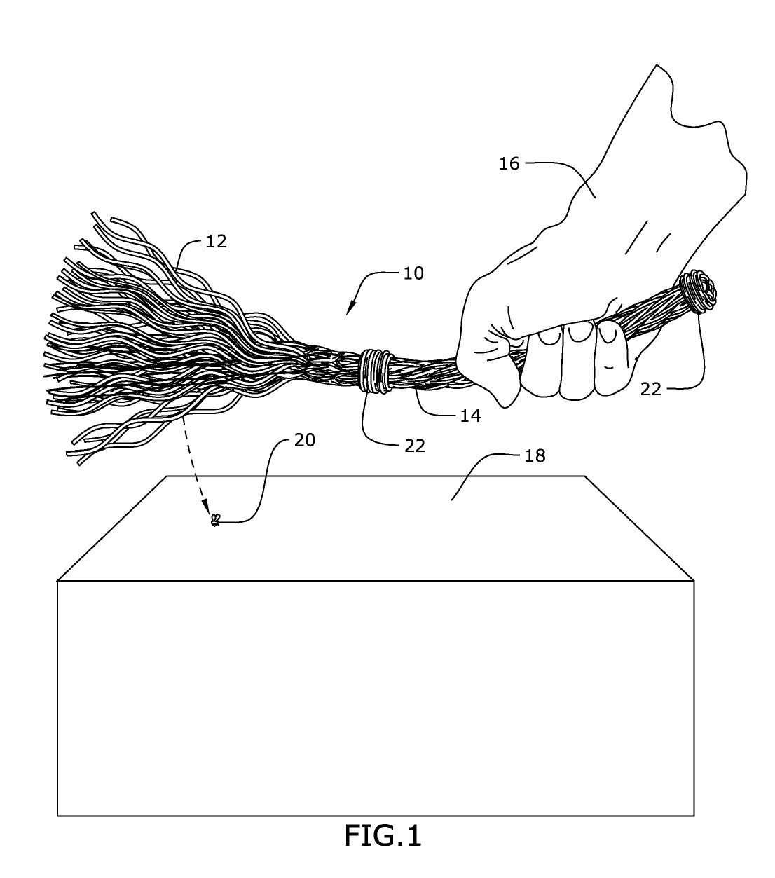

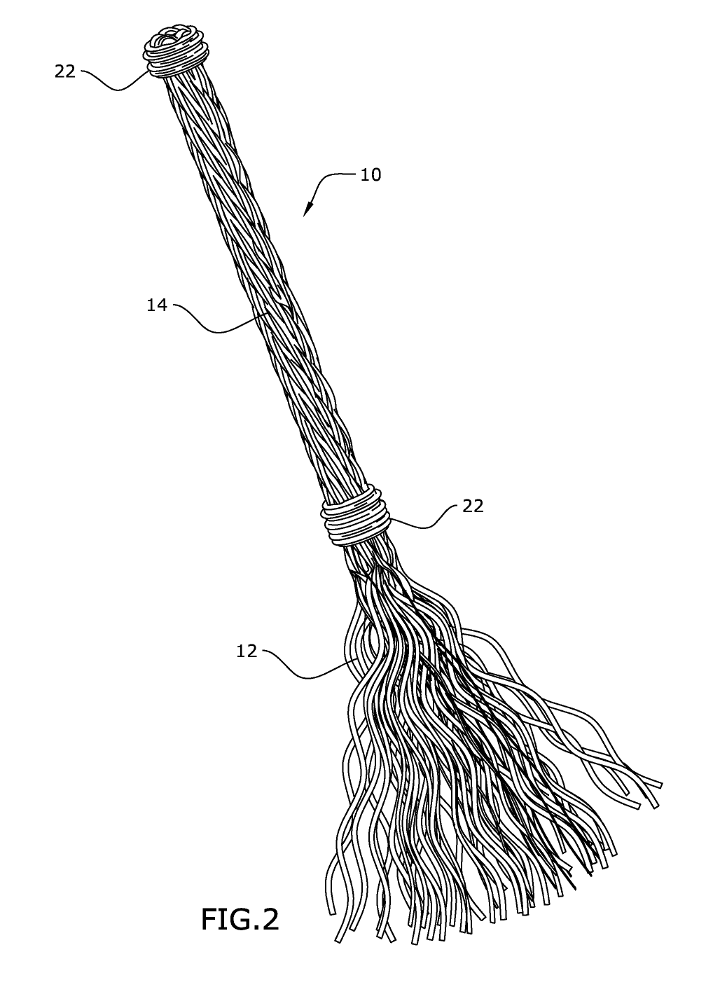

Referring to FIGS. 1 and 2, the present invention may include an insect swatter 10. The insect swatter 10 may include a plurality of limp fibers formed into a handle portion 14, by braiding a first portion of the limp fibers, and a striking portion 12, by leaving a second portion of the limp fibers un-braided. Such a unitary construction facilitates lower manufacturing costs and less problematic raw material acquisition.

The limp fibers may be made from synthetic or natural material. The synthetic material may include, but not be limited to, nylon, plasticized material and the like. The natural material may include, but not be limited to, cotton, leather, hemp and the like. The limp fibers material may exhibit a limp, soft and resilient manner for delivering a soft impact while also exhibiting properties tolerant of shape changes, for instance, when for fitting into tight spaces.

The handle portion 14 may be formed by braiding and/or weaving a portion of the plurality of limp fibers, whereby the non-braided/woven portion of the plurality of limb fibers forms the striking portion 12. In certain embodiments, the handle portion 14 may be approximately four to six inches in length. The braided/woven limp fiber, or handle portion 14, may be bound tightly with at least one separate limp fiber, twine, string, cord, sewn cloth or the like band 22 on both opposing ends. In certain embodiments, one band 22 may be disposed along the handle portion 14 approximately three-quarters to one inch from each end thereof. A method of using the present invention may include the following.

Holding the handle portion 14, a user 16 may, with a wrist flip or forearm motion, accelerate the striking portion 14 to strike an intended insect 20 on an object 18. Because of the limp, soft manner a successful strike may result in a stunned insect 20 that can easily be discarded without leaving a messy residue. With more excessive force, the strike can be lethal. The shape-tolerant properties allow for either of these types strikes to happen in tight spaces, as the striking portion 12 conforms to the allowable space. Moreover, the strike can take place in the air, and so the user need not wait for the targeted insect to land on the object 18.

It should be understood, of course, that the foregoing relates to exemplary embodiments of the invention and that modifications may be made without departing from the spirit and scope of the invention as set forth in the following claims.

What is claimed is:

1. An insect swatter comprising:
a plurality of limp fibers, wherein a first portion of the plurality of limp fibers is braided.

2. The insect swatter of claim 1, further comprising two bands, wherein each band is bound tightly about the braided first portion of the plurality of limp fibers, and wherein each band is disposed near opposing ends thereof.

3. The insect swatter of claim 1, wherein the braided first portion of the plurality of limp fibers is approximately four to six inches in length.

4. An insect swatter comprising:
a first portion of a plurality of limp fibers forming a striking portion; and
a second portion of the plurality of limp fibers braided to form a handle portion.

5. The insect swatter of claim 4, further comprising two bands, wherein each band is bound tightly about the braided first portion of the plurality of limp fibers, and wherein each band is disposed near opposing ends thereof.

6. The insect swatter of claim 4, wherein the handle portion is approximately four to six inches in length.

7. A method of making an insect swatter that can strike in tight spaces from a unitary limp material, comprising:
rendering the unitary limp material into a plurality of limp fibers; and
braiding a first portion of the plurality of limp fibers.

8. The method of claim 7, further including tightly binding at least one limp fiber around each opposing end of the braided first portion.

9. The method of claim 7, wherein each limp fiber is approximately seven to ten inches in length.
